(19) United States
(12) Patent Application Publication
(10) Pub. No.: US 2003/0133254 A1
(43) Pub. Date: Jul. 17, 2003

(54) Light-weight reinforced electreochemical capacitor and process for making the same

(76) Inventor: Zheng Chen, Dublin, OH (US)

Correspondence Address: John L. Isaac, Esq., Isaac & Associates, Suite 900, 143 Union Blvd., Lakewood, CO, 80228-1829, US

(21) Appl. No.: 10/050,671

(22) Filed: Jan. 16, 2002

(51) Int. Cl. H01G 9/08; H01M 2/02; H01M 4/64

(52) U.S. Cl. 361/517; 156/245; 156/295; 429/176; 429/233; 429/152; 361/522

(57) ABSTRACT

An electrochemical capacitor cell is provided. The cell includes a cathode having a coating of an amorphous metal oxide, and an anode having a coating of an amorphous metal oxide. An electrolyte layer is disposed between the cathode and anode, and first and second current collectors are disposed, respectively, adjacent the outer surfaces of the cathode and anode. A conductive resin coating then surrounds the exterior surfaces of the cathode and anode and their respective current collectors to provide an exterior packaging having rigidity and strength for the cell. Additionally, a process for forming the light-weight reinforced capacitor is provided. The process includes creating a die member having first and second mating components. The first component is in the form of a die mold having a recessed area, and the second component is in the form of a mating die punch sized and shaped to fit the recessed area of the first component. At least one electrochemical capacitor cell is sandwiched between a pair of fibrous sheet preforms to form a preform sandwiched capacitor. The preform sandwiched capacitor is positioned in the recessed area of the die mold, and epoxy resin is then placed in the recessed area having the preform sandwiched capacitor therein. The second component mating die punch is then compressed into the recessed area to force the epoxy resin into the preform sheets and encase the sandwiched capacitor. The compression is maintained for a time sufficient to cure the epoxy resin. Finally, the second component mating die punch is withdrawn from the first component recessed area, and the resin encased sandwiched capacitor is removed.

### RELATED APPLICATIONS

This application relates to my U.S. patent application Ser. No. ______, filed ______, and entitled “Electrochemical Capacitor Having Low Internal Resistance”, as well as my U.S. patent application Ser. No. ______, filed ______, and entitled “Thin-Coat Metal Oxide Electrode for an Electrochemical Capacitor”, the contents of which are specifically incorporated herein by reference.

### BACKGROUND OF THE INVENTION

1. Field of the Invention

The present invention relates generally to rechargeable electrochemical capacitors and, more particularly, to electrochemical capacitors having low internal resistance, high charge/discharge rates and excellent power density. Specifically, the present invention relates to improved capacitors comprised of one or more electrochemical cells and contained in a lightweight reinforced casing

2. Description of the Prior Art

Electrochemical capacitors are devices which store electrical energy at the interface between an ionically-conducting electrolyte phase and an electronically-conducting electrode material. Electrochemical capacitors are a class of high rate energy storage devices which use such electrolytes and electrodes of various kinds in a system similar to that of conventional batteries. The electrochemical capacitors, like batteries, are essentially energy storage devices. However, unlike batteries, capacitors rely on charge accumulation at the electrolyte/electrode interface to store energy. Charge storage in electrochemical capacitors therefore is a surface phenomena. Conversely, charge storage in batteries is a bulk phenomena occurring within the bulk of the electrode material.

Electrochemical capacitors can generally be divided into one of two subcategories. Double layer capacitors involved those in which the interfacial capacitance at the electrode/electrolyte interface can be modeled as two parallel sheets of charge. Pseudocapacitor devices, on the other hand, are those in which charge transfer between the electrolyte and the electrode occurs over a wide potential range and is the result of primary, secondary, and tertiary oxidation/reduction reactions between the electrode and the electrolyte. These types of electrochemical capacitors are currently being developed for high pulse power applications such as in cellular telephones.

Most of the known electrochemical capacitor active materials for both cathode and anode structures are based on metallic elements such as platinum, iridium, ruthenium, or cobalt. These materials are generally quite expensive and pose a significant hurdle to the widespread commercialization of this technology. Moreover, electrochemical capacitor devices have also suffered from problems associated with the manufacture and packaging of such devices. It is the nature of electrochemical capacitors to require relatively small packages which preferably develop high pulse power spikes and require high charge/discharge rates. Prior techniques of assembling such devices typically increased the thickness of the device as well as the complexity of the manufacturing process. Increased complexity resulted in manufacturing defects which caused yield losses. Moreover, as the capacitor package became thicker due to processing, the introduction of electrode equivalence series resistance (ESR), in other words internal resistance, reduced the efficiencies of the fabricated devices as well as decreased the charge/discharge rates.

One previous approach to this problem was to fabricate the capacitor by placing the cell or series of cells which made up the capacitor under high physical pressure. While this increased compression approach to fabrication reduced the internal resistance in the device, it created by a whole new set of fabrication problems. Therefore, there remains a need to provide electrochemical capacitor devices which feature low internal resistance, thin profiles and high charge/discharge rates without the inherent problems associated with high pressure containers and compression fabrication techniques. Moreover, there remains a need for packaging arrangements for such capacitors which eliminates compression structures while still maintaining reduced internal resistance in the device. The present invention addresses this significant problem.

### SUMMARY OF THE INVENTION

Accordingly, it is one object of the present invention to provide an improved capacitor device.

It is another object of the present invention to provide a capacitor having low internal resistance, high charge/discharge rates, good energy density and excellent power density.

Yet another object of the present invention is to provide a capacitor structure having a reinforced casing and which yields efficient capacitor output without requiring a high pressure packaging for the device.

Still another object of the present invention is to provide a process for making a light-weight reinforced electrochemical capacitor.

To achieve the foregoing and other objects and in accordance with the purpose of the present invention, as embodied and broadly described herein, an electrochemical capacitor cell is provided. The cell includes a cathode having a coating of an amorphous metal oxide, and an anode having a coating of an amorphous metal oxide. An electrolyte layer is disposed between the cathode and anode, and first and second current collectors are disposed, respectively, adjacent the outer surfaces of the cathode and anode. A conductive resin coating then surrounds the exterior surfaces of the cathode and anode and their respective current collectors to provide an exterior packaging having rigidity and strength for the cell.

An alternate modification of the invention includes a light-weight reinforced electrochemical capacitor which is formed from a plurality of stacked electrochemical cells. Each of the cells includes a pair of electrodes having amorphous metal oxide therein with the electrodes being separated by an electrolyte soaked layer. The stack of cells has first and second end surfaces, and a conductive layer is interposed between adjacent stacked electrochemical cells. A pair of conductive end layers cover, respectively, the first and second end surfaces of the stacked electrochemical cells, while first and second current collectors are disposed, respectively, proximately adjacent the pair of conductive end layers. Finally, a conductive resin coating encases the outermost surfaces of the stacked cells to provide an exterior casing for the capacitor which in turn provides rigidity and strength without requiring the application of external pressure.

Additionally, a process for forming the light-weight reinforced capacitor is provided. The process includes creating a die member having first and second mating components. The first component is in the form of a die mold having a recessed area, and the second component is in the form of a mating die punch sized and shaped to fit the recessed area of the first component. At least one electrochemical capacitor cell is sandwiched between a pair of fibrous sheet preforms to form a preform sandwiched capacitor. The preform sandwiched capacitor is positioned in the recessed area of the die mold, and epoxy resin is then placed in the recessed area having the preform sandwiched capacitor therein. The second component mating die punch is then compressed into the recessed area to force the epoxy resin into the preform sheets and encase the sandwiched capacitor. The compression is maintained for a time sufficient to cure the epoxy resin. Finally, the second component mating die punch is withdrawn from the first component recessed area, and the resin encased sandwiched capacitor is removed. The different contraction of the resin during its curing due to the arranged fibrous preforms result in a compressive stress which further reduce the cell's ESR.

### BRIEF DESCRIPTION OF THE DRAWINGS

The accompanying drawings which are incorporated in and form a part of the specification illustrate preferred embodiments of the present invention and, together with a description, serve to explain the principles of the invention. In the drawings:

FIG. 1 is a side sectional view of a single electrochemical cell capacitor constructed for use with the present invention;

FIG. 2 is a side sectional view of a capacitor constructed for use with the present invention and illustrating a plurality of stacked electrochemical cells therein;

FIG. 3 is a side sectional view of the capacitor of FIG. 1 sandwiched between a pair of fibrous preform sheets;

FIG. 4 is a side sectional view of a die member first component in the form of a die mold having a recessed area and illustrating the preform sandwiched capacitor of FIG. 3 positioned therein;

FIG. 5 is a side sectional view of the die member first component of FIG. 4 but illustrating the application of epoxy resin in the recess thereof;

FIG. 6 is a side sectional view of the die member first component of FIG. 5 along with the second component mating die punch in position to be compressed into the recessed area of the first component to force the epoxy resin into the preform sheets and encase the sandwiched capacitor with epoxy resin;

FIG. 7 is a side perspective view of the epoxy resin encased capacitor resulting from the final process step illustrated in FIG. 6;

FIG. 8 is a graph illustrating the pulse performance with pulsing time of a 6-cell capacitor manufactured in accordance with the process of the present invention; and

FIG. 9 is a graph illustrating the pulse performance of the same 6-cell capacitor of FIG. 8 at 10 kHz.

### DETAILED DESCRIPTION OF THE PREFERRED EMBODIMENTS

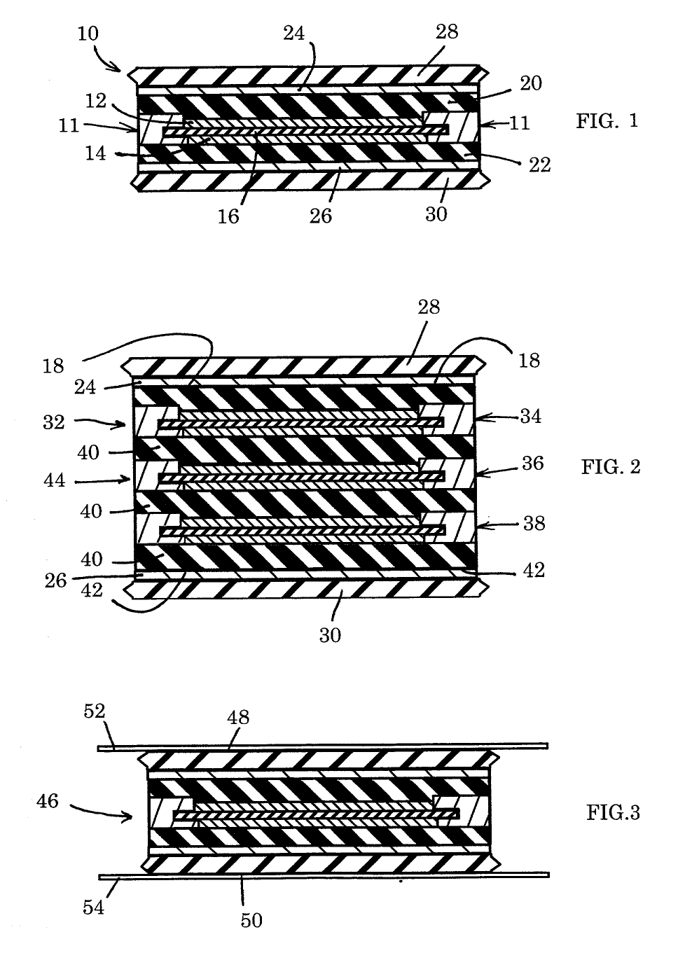

Referring now to FIGS. 1 and 2, a capacitor 10 is illustrated utilizing the known prior art technique of applying pressure to the capacitor cell during both fabrication and storage in order to ensure good interparticle contact within the capacitor cells so as to minimize internal resistance therewithin. The capacitor 10 preferably includes a stack 11 having a plurality of individual electrochemical cells 12, 14 and 16 arranged in a stacked alignment. The stack of cells 11 include an upper end surface 18 and a lower end surface 20. Each cell 12, 14 and 16 is constructed in a similar manner and includes an anode 22 and a cathode 24 separated by a separator 26 soaked with electrolyte. In preferred form, the anode 22, cathode 24 and electrolyte layer 26 are arranged within an insulator ring 28. The cells 12, 14 and 16 are in turn separated from each other by a plurality of conductive rubber elements 30. Finally, an upper conductive rubber element 32 and a lower conductive rubber element 34 form the end surfaces 18, 20, respectively.

Referring now to FIG. 1, a capacitor 10 made up of a single electrochemical cell 11 is constructed and includes an anode 12 and a cathode 14 preferably made from oxides of various metals and specifically ruthenium, iridium, cobalt, nickel, molybdenum, tungsten, manganese, titanium, tantalum and zinc. In preferred form, both the anode 12 and cathode 14 structures are made from amorphous hydrated ruthenium oxide. The anode and cathode 12, 14 are separated by an electrolyte layer 16. In preferred form, the electrolyte layer 16 includes a substrate containing a liquid electrolyte, and most preferably sulfuric acid. In preferred form, the anode 12, cathode 14 and electrolyte soaked separator 16 are sealed by an insulator ring 18.

In the illustrated capacitor 10, both surfaces of the electrochemical cell 11, that is the exterior surfaces of the end of the anode 12 and the cathode 14, are preferably covered by a conductive rubber element 20, 22, respectively. The conductive rubber element in preferred form includes a composite structure having natural rubber and carbon powder and/or fiber therein. A metallic coating or layer 24 is deposited onto the exterior surface of the conductive rubber element 20 while a similar metallic coating or layer 26 is deposited onto the exterior or outer surface of the conductive rubber element 22. In this manner, the metallic coatings 24, 26 are interposed between the conductive rubber elements 20, 22 and the current collectors 28, 30 proximate thereto. In preferred form, the metallic coatings 24, 26 comprise a thin layer, most preferably 0.0025-0.100 mm in thickness, of a metal designed as an intermediate layer between the terminal and the conductive rubber to reduce contact resistance and subsequent internal cell resistance. In preferred form, the metallic coatings 24, 26 are selected from any appropriate metal such as Ag, Cu, stainless steel, Al, Ti, Ni, Au, Pt, Ta and alloys thereof such as Inconel. The metallic coating layers 24, 26 do not directly contact the corrosive electrolyte layer 16 and is separated from the electrolyte by the conductive rubber layers 20, 22, respectively. Most preferably, the metallic coating is Ag due to the combination of performance and cost.

Referring now to FIG. 2, the capacitor 32 illustrated therein is substantially similar to the structure illustrated in FIG. 1 only that it includes a plurality of electrochemical cells 34, 36 and 38 similar to the cell 11 of FIG. 1. The individual electrochemical cells 34, 36 and 38 are each constructed in the same manner as that discussed and illustrated in detail for the cell 11 of FIG. 1 and are separated from each other by conductive rubber layers 40, as in the capacitor cell 11 of FIG. 1. In this particular embodiment, the uppermost layer 18 and the lowermost layer 42 of the stack 44 of cells 34, 36 and 38 are covered by the metallic coatings 24, 26 as in FIG. 1. In this manner, the metallic coatings 24, 26 are interposed between the stack 44 and the current collectors 28, 30. As a result of the structure of the capacitors 10, 32, it is not necessary to exert pressure or compression thereon to achieve low internal resistance as well as high charge/discharge rates.

Referring now to FIG. 3, the capacitor 46 illustrated therein may be in the form of the capacitor 10 of FIG. 1, the capacitor 32 of FIG. 2, or any other similar type of electrochemical capacitor having a plurality of stacked cells 11. The upper and lower outer surfaces 48, 50 thereof are covered respectively by layers 52, 54 of a fibrous preform. The preform layers 52, 54 are preferably made from a dimensionally stable fibrous sheet material fabricated and tailored to the desired size to cover and overlap the surfaces 48, 50. The capacitor cell or cell stack of the capacitor 46 is thus sandwiched between the two fibrous preform sheets 52, 54.

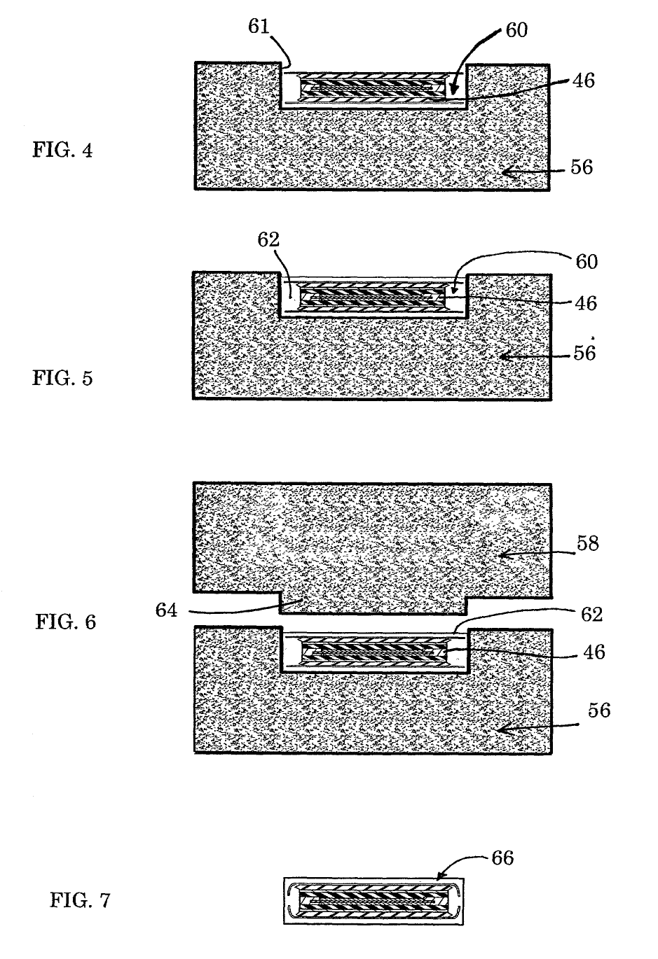

Referring now to FIGS. 4-7, a die member is created in the form of first and second mating components 56, 58. The first component 56 is preferably in the form of a die mold having a recessed female cavity 60 sized and shaped to receive the desired size and shape of the capacitor 46. The sandwiched capacitor 46 is then positioned in the cavity 60, the cavity 60 being of sufficient size to create a slight gap between the deposited sandwiched capacitor 46 and the internal walls 61 of the cavity 60. Epoxy resin 62 is then placed into the cavity 60 to surround the sandwiched capacitor 46 and saturate the preform layers 52, 54. In preferred form, the epoxy resin 62 is a high temperature thermosetting resin preferably having fibers intermixed therein. The fibers provide additional strength and reinforcement to the final capacitor product and are preferably ceramic and most preferably alumina fibers.

Once the epoxy resin 62 has been placed in the cavity 60, the male punch portion 64 of the first component 58 is moved into the cavity 60 to compress the epoxy resin 62 and the sandwiched capacitor 46 within the cavity 60. Once the desired displacement is achieved, the punch 64 is stopped and held in position while the resin is cured. Curing of the resin takes place by heating the die components 56, 58 in addition to the heat of compression caused by the punch 64. In addition, the compression from the punch 64 drives the epoxy resin into the preform layers 52, 54 to saturate them before curing is complete. Once curing is complete, the die components 56, 58 are separated and the resulting encased capacitor 66 is removed from the cavity 60.

The capacitor 66 is encased in fiber reinforced epoxy resin. With reinforcement from the preferred alumina fiber, the encased capacitor displays high strength and stiffness and good temperature stability up to 85° C. Additionally, because of the low density of the alumina fibers and epoxy resin, the resulting capacitor 66 is light weight with good energy density and excellent power density Specifically, when the capacitor 46 is initially fabricated with 6 cells, the resulting encased lightweight capacitor 66 displayed a specific energy density (max) of 1.26 J/g or 2.08 J/cm³ and a specific power density (max) of 125 W/g or 207 W/cm³.

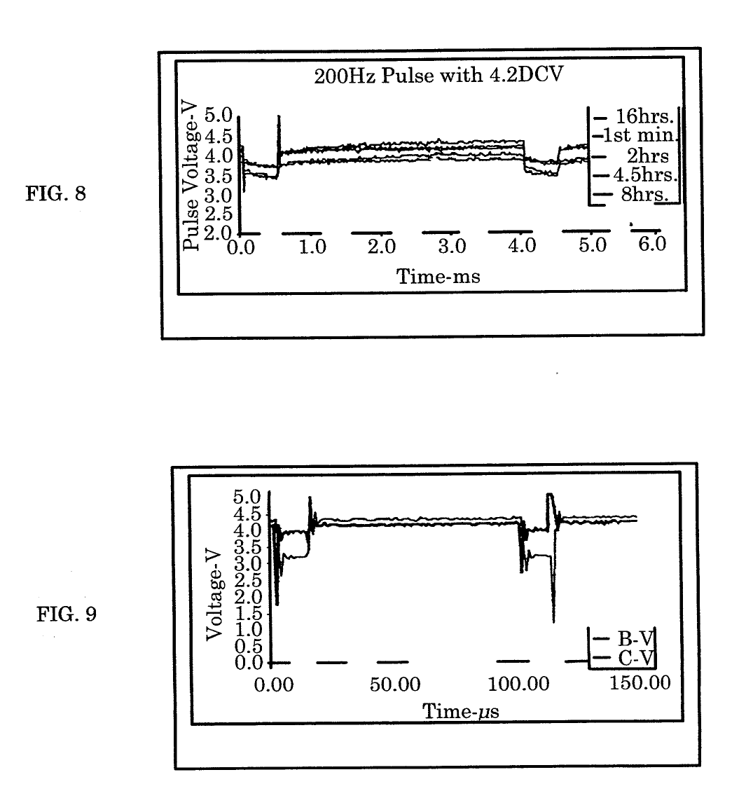

Fabricating a 6-cell capacitor in accordance with the present invention, the resulting capacitor improved the pulse power capacity up to 37W and high pulse rate up to 100 Khz for a 6-cell and 180 mF capacitor. The 5V 190 mF capacitor was continuous delivering 8W pulse at the rate of 200 Hz for 15 hours (10.8 million pulses). FIG. 8 illustrates the pulse performance of the capacitor with pulsing time. Moreover, the capacitor pulse rate improved up to 100 khz. FIG. 9 illustrates the pulse performance at a 10 khz rate.

As can be seen from the above, the present invention provides for a capacitor structure and device which does not require high pressure or compression as part of the fabrication containment arrangement. Nonetheless, the capacitor of the present invention provides a light weight, reinforced capacitor device having significant capacitance capability and high charge/discharge rates while providing significantly lower contact resistance and internal resistance therewithin. This provides for higher efficiency and longer life times for the capacitor constructed in accordance with a present invention. Moreover, the present invention provides a method of manufacturing encased lightweight capacitors having reinforced containment while having high pulse power capability, good energy density and excellent power density.

The foregoing description and the illustrative embodiments of the present invention have been described in detail in varying modifications and alternate embodiments. It should be understood, however, that the foregoing description of the present invention is exemplary only, and that the scope of the present invention is to be limited to the claims as interpreted in view of the prior art. Moreover, the invention illustratively disclosed herein suitably may be practiced in the absence of any element which is not specifically disclosed herein.

I claim:

1. An electrochemical capacitor cell, said cell comprising:
a cathode having a coating of an amorphous metal oxide;
an anode having a coating of an amorphous metal oxide;
an electrolyte soaked separator disposed between said cathode and anode;
first and second current collectors disposed, respectively, adjacent the outer surfaces of said cathode and anode; and
a conductive resin coating surrounding the exterior surfaces of said cathode and anode and their respective current collectors to provide an exterior packaging having rigidity and strength for said cell.

2. The electrochemical capacitor cell as claimed in claim 1, wherein said cell further comprises a fibrous preform layer covering the exterior surface thereof with said resin coating surrounding and penetrating said preform layer to generate a compressive stress in the resin to reduce the ESR of said cell.

3. The electrochemical capacitor cell as claimed in claim 1, wherein said epoxy resin coating includes fibers therein.

4. The electrochemical capacitor cell as claimed in claim 3, wherein said fibers comprise ceramic fibers.

5. The electrochemical capacitor cell as claimed in claim 1, wherein the capacitor comprises a plurality of said cells aligned in a stacked arrangement, said stacked cells being encased in said epoxy resin.

6. The electrochemical capacitor cell as claimed in claim 1, wherein said cell further includes a conductive layer interposed between the exterior surface of each said cathode and anode and its respective current collector.

7. The electrochemical capacitor cell as claimed in claim 6, wherein said epoxy resin coating includes ceramic fibers therein.

8. A light-weight reinforced electrochemical capacitor comprising:
a plurality of stacked electrochemical cells each said cell including a pair of electrodes having amorphous metal oxide therein with said electrodes being separated by an electrolyte soaked layer, said stack of cells having first and second end surfaces;
a conductive layer interposed between adjacent stacked electrochemical cells;
a pair of conductive end layers covering, respectively, said first and second end surfaces of said stacked electrochemical cells;
first and second current collectors disposed, respectively, proximately adjacent said pair of conductive end layers; and
a conductive resin coating encasing the outermost surfaces of said stacked cells to provide an exterior casing for said capacitor providing rigidity and strength without application of external pressure.

9. The electrochemical capacitor as claimed in claim 8, wherein said capacitor further includes a metallic coating disposed on the outermost end surfaces of said stacked cells to further reduce contact resistance.

10. The electrochemical capacitor as claimed in claim 9, wherein said conductive layers comprise conductive rubber.

11. The electrochemical capacitor as claimed in claim 8, wherein, said capacitor further comprises a fibrous preform layer covering the exterior surface of said stacked cells with said resin coating surrounding and penetrating said preform layer.

12. The electrochemical capacitor as claimed in claim 11, wherein said fibers comprise ceramic fibers.

13. The electrochemical capacitor as claimed in claim 12, wherein said fibers comprise alumina or SiC fibers.

14. A process for forming a light-weight reinforced capacitor comprising:
creating a die member having first and second mating components, said first component being in the form of a die mold having a recessed area, and said second component being in the form of a mating die punch sized and shaped to fit said recessed area;
sandwiching at least one electrochemical capacitor cell between a pair of fibrous sheet preforms to form a preform sandwiched capacitor:
positioning the preform sandwiched capacitor in the recessed area of said die mold;
placing epoxy resin in the recessed area having said preform sandwiched capacitor therein;
compressing said second component mating die punch into said recessed area to force the epoxy resin into said preform sheets and to encase said sandwiched capacitor with said epoxy resin;
maintaining said compression for a time sufficient to cure said epoxy resin;
withdrawing said second component mating die punch from said first component recessed area; and
removing said resin encased sandwiched capacitor.

15. The process as claimed in claim 14, wherein said preform sandwiched capacitor comprises a plurality of stacked electrochemical cells.

16. The process as claimed in claim 14, wherein said perform sheet comprises a dimensionally stable fibrous perform sheet.

17. The process as claimed in claim 14, wherein said epoxy resin comprises a high temperature thermosetting epoxy resin.

18. The process as claimed in claim 17, wherein said thermosetting epoxy resin includes fibers therein.

19. The process as claimed in claim 18, wherein said thermosetting epoxy resin includes alumina fibers therein.

20. The process as claimed in claim 19 wherein said preform sandwiched capacitor comprises a plurality of stacked electrochemical cells, and wherein said epoxy resin comprises a low density, high temperature thermosetting epoxy resin containing alumina fibers.
